(19) United States
(12) Patent Application Publication
(10) Pub. No.: US 2025/0317308 A1
(43) Pub. Date: Oct. 9, 2025

(54) AUTOMATED VALIDATION OF CERTIFICATE SIGNING REQUESTS FOR MOBILE NETWORK FUNCTIONS

(71) Applicant: Cisco Technology, Inc., San Jose, CA (US)

(72) Inventors: Charles U. Eckel, Los Altos, CA (US); Richard Lee Barnes, Arlington, VA (US)

(21) Appl. No.: 19/021,618

(22) Filed: Jan. 15, 2025

Related U.S. Application Data
(60) Provisional application No. 63/573,545, filed on Apr. 3, 2024.

(51) Int. Cl. H04L 9/32

(52) U.S. Cl. CPC H04L 9/3268; H04L 9/3213; H04L 9/3271

(57) ABSTRACT

Provided herein are techniques to facilitate automated validation of certificate signing requests for network functions. In at least one instance, a method is provided that may include, for a certificate enrollment process for a network function (NF) of a mobile core network, transmitting a certificate order to a certificate authority service that includes an identifier of the NF identified in an authority token that the NF obtains from a token authority service. Through the certificate enrollment process, the NF transmits the authority token to the certificate authority service for validation. Upon validation of the token by the certificate authority service, the NF can obtain a signed certificate that enables the NF to communicate with other network functions of the mobile core network. The method may be performed using the Automated Certificate Management Environment (ACME) protocol within a Third Generation Partnership Project (3GPP) mobile network architecture.

### PRIORITY CLAIM

This application claims the benefit of priority under 35 U.S.C. § 119 to U.S. Provisional Application No. 63/573,545, filed on Apr. 3, 2024, the entirety of which application is incorporated herein by reference.

### TECHNICAL FIELD

The present disclosure relates to network equipment and services.

### BACKGROUND

Networking architectures have grown increasingly complex in communications environments, particularly wireless networking environments. For example, mobile communication networks have grown substantially as end users become increasingly connected to mobile network environments. In wireless mobile core network architectures, network functions can be deployed to provide various network services. However, there are significant challenges with regard to deploying network functions in mobile core networks.

### BRIEF DESCRIPTION OF THE DRAWINGS

FIG. 1A is a block diagram of a system that can be implemented to facilitate automated validation of certificate signing requests for mobile core network functions, according to an example embodiment.

FIG. 1B is a sequence diagram depicting provisioning of an authority token for a mobile core network function via the system of FIG. 1A, according to an example embodiment.

FIG. 2 is a sequence diagram depicting a certificate enrollment process that can be performed between a mobile core network function and an operator certificate authority/registration authority through which automated validation of a certificate signing request from the mobile core network function can be performed, according to an example embodiment.

FIG. 3 is a flow chart depicting a method according to an example embodiment.

FIG. 4 is a flow chart depicting another method according to an example embodiment.

FIG. 5 is a flow chart depicting another method according to an example embodiment.

FIG. 6 illustrates a hardware block diagram of a computing device configured to perform functions associated with operations discussed in connection with embodiments herein.

### DETAILED DESCRIPTION

### Overview

The Third Generation Partnership Project (3GPP) Fifth Generation (5G) core network (5GC) Service Based Architecture (SBA) is an example of an environment in which certificates can be used to establish secure communications and/or connections among a large number of network functions. Virtualization and increased modularity of network functions has resulted in multi-vendor environments becoming more prevalent in mobile core networks. It is now common for network functions to come from different vendors, for the cloud native environment in which they run to come from yet another vendor, and for all of these to be independent of a Certificate (or Certification) Authority (CA) that is authoritative for the certificates used to secure communications. In such environments, it may be extremely advantageous to be able to automate the validation of certificate signing requests (also referred to more generally herein as certificate requests) and eliminate reliance on self-signed certificates and/or manual certificate validation.

Embodiments herein provide techniques to facilitate automated validation of certificate signing requests/certificate requests, for network functions in a mobile core network environment.

In at least one embodiment, a computer-implemented method is provided that may include obtaining, from a token authority service, a certificate authority token that identifies at least an instance identifier (ID) of the NF, wherein the token authority service has a pre-established trust relationship with a certificate authority service; for a certificate enrollment process, transmitting a certificate order to the certificate authority service that includes the instance ID of the NF identified in the certificate authority token; obtaining a response from the certificate authority service that includes an authorization internet address for the certificate authority service; transmitting a challenge query to the certificate authority service via the authorization internet address; obtaining a challenge response from the certificate authority service indicating an authority token challenge type for validating the certificate authority token of the NF and including a challenge internet address; transmitting the certificate authority token obtained from the token authority service to the certificate authority service via the challenge internet address; and upon validation of the certificate authority token by the certificate authority service, obtaining, from the certificate authority service, a signed certificate or a certificate internet address from which the NF is to obtain the signed certificate for the certificate enrollment process.

### Example Embodiments

In a mobile core network environment, such as a Third Generation Partnership Project (3GPP) 5G core (5GC) network, a next Generation (nG) mobile core network, or the like, it may be desirable to provide an automated way/technique for a mobile core network function (NF) to obtain certificates to establish secure communications within a network. Such a mobile core NF may be a physical network function or a virtual network function, such as a container workload running in a cloud native environment such as Kubernetes®.

Automated certificate solutions have been developed for other domains, such as devices or systems responsible for one of more E.164 phone numbers, for example, as provided per Internet Engineering Task Force (IETF) Request for Comments (RFC) 9448, but such issues have not been solved for the general domain of network functions or for the specific domain of 5GC NFs.

Broadly, embodiments herein may provide techniques to facilitate automated validation of certificate signing requests/certificate requests for network functions using the Automated Certificate Management Environment (ACME) protocol. In contrast to current solutions for 5GC NFs that rely on manual processes to validate certificate signing requests, embodiments herein provide automated and programmatic techniques to validate certificate signing requests/certificate requests using an ACME architecture that can be operated using the ACME protocol. For example, at least one embodiment may provide for enabling an automated technique for a mobile core network function (NF) to create and/or otherwise obtain authorized certificates that the NF can use to establish secure connections within a 5G Service Based Architecture (SBA), for example, with other NFs in such an architecture.

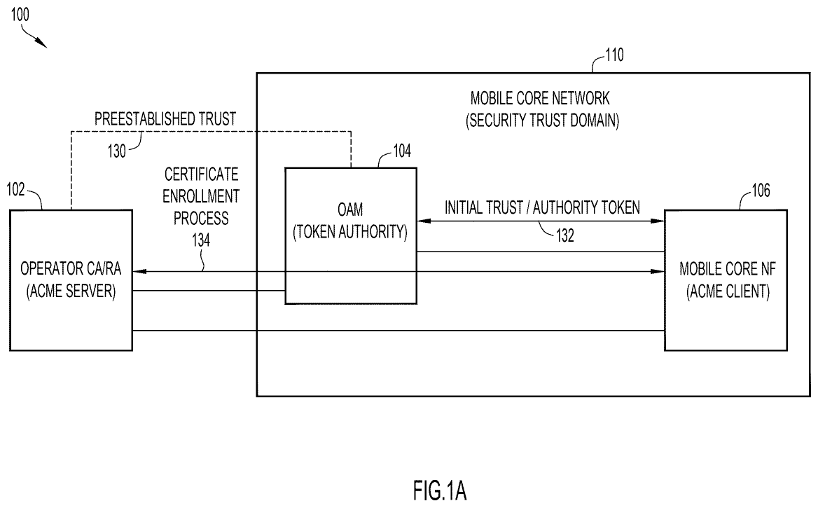

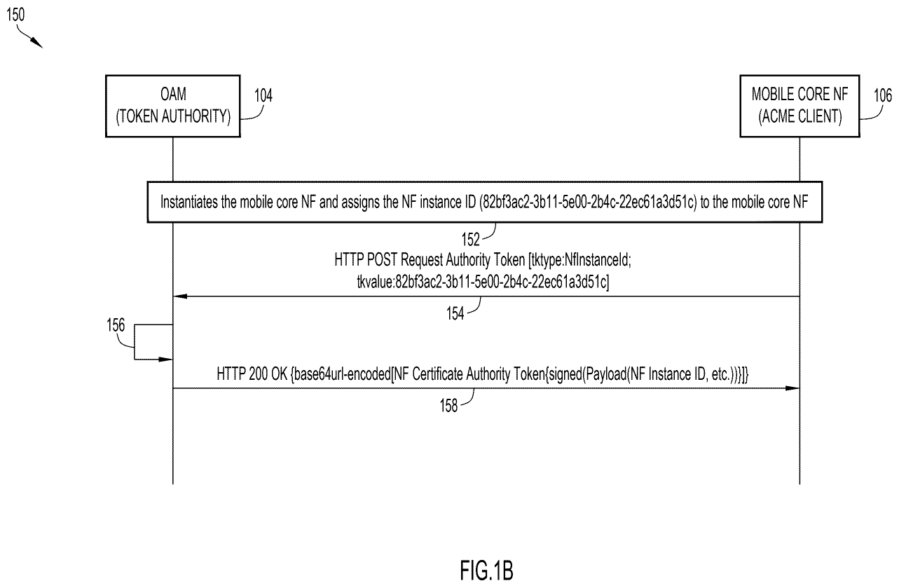

Referring to FIG. 1A, FIG. 1A is a block diagram of a system 100 that may be implemented to facilitate automated validation of certificate signing requests for network functions, according to an example embodiment. In at least one embodiment, system 100 may include an operator Certificate (or Certification) Authority (CA)/Registration Authority (RA), shown in FIG. 1A as operator CA/RA 102, an Operations, Administration, and Maintenance (OAM) system, referred to herein as OAM 104, and at least one mobile core NF, such as mobile core NF 106. As referred to herein, the operator CA/RA 102 may generally be referred to as a ‘certificate authority service’.

Mobile core NF 106 may be one of many NFs provided for a mobile core network 110 that may include OAM 104. Thus, although not shown in FIG. 1A, mobile core network 110 can include a plurality of mobile core NFs, each interfacing with the OAM 104 and the operator CA/RA 102 in the manner as depicted for mobile core NF 106, and potentially interfacing with each other, per 3GPP and/or any other mobile network standards, security standards, certificate management standards, and/or any other standards, guidelines, protocols, RFCs, etc., as may be appropriate.

The mobile core network 110 may be characterized as a security trust domain including the OAM 104 and the (at least one) mobile core NF 106. In some embodiments, the operator CA/RA 102 may be considered to be part of the mobile core network 110.

Generally, the operator CA/RA 102 interfaces with the OAM 104, which further interfaces with mobile core NF 106. The mobile core NF 106 also interfaces with the operator CA/RA 102. In various embodiments, the operator CA/RA 102, the OAM 104, and the mobile core NF 106 can be operated by any combination of a mobile network operator (MNO), one or more network function vendors, and/or one or more network operators.

Generally, the operator CA/RA 102 may include a CA element or logic and an RA element or logic. Generally, a CA element or logic is a Public Key Infrastructure (PKI) entity that issues X.509 certificates and an RA element or logic is an optional PKI entity that does not issue certificates but rather can be delegated by the CA to receive and evaluate certificate signing requests (e.g., certificate enrollment, as discussed herein), potentially verify such requests, and then forward them to the CA that can issue an X.509 certificate. Thus, a CA/RA, such as operator CA/RA 102 can be considered any PKI entity or combination of entities operated by a network operator that issues and makes available certificates (also referred to herein as signed certificates) for NFs. Aside from such conventional features, the operator CA/RA 102 may be enhanced to facilitate/provide other features/operations as discussed for embodiments herein. Generally, the OAM 104, may facilitate/provide functionality for provisioning and/or managing a network and/or an element of a network, such as a NF, among other features/operations, which may be performed in accordance with embodiments herein.

The mobile core NF 106 may be implemented as any NF that may be provided in a mobile core network (e.g., per 3GPP standards, etc.), including, but not limited to User Plane Functions (UPFs), Session Management Functions (SMFs), Access and Mobility Management Functions (AMFs), Policy Control Functions (PCFs), Network Slice Management Functions (NSMFs), and/or the like.

The ACME protocol is defined in various Internet Engineering Task Force (IETF) Request for Comments (RFC) standards, such as RFC 8555, RFC 9447 (extensions to the ACME protocol), and RFC 9448, among others.

When operating under the ACME protocol, in at least one embodiment, the OAM 104 can operate as a Token Authority (also interchangeably referred to herein as a ‘token authority service’) that is trusted by the operator CA/RA 102, such that a preestablished trust 130 is provided between the operator CA/RA and the OAM 104 for embodiments herein. As such, the OAM 104 may be trusted to act as an authority for an NF Instance ID namespace within the mobile core network 110. Further, when operating under the ACME protocol, the operator CA/RA 102 can operate as an ACME server and the mobile core NF 106 can operate as an ACME client. For example, the operator CA/RA 102 can include ACME server logic (not shown) to perform ACME server operations, and the mobile core NF 106 can include ACME client logic (not shown) to perform ACME client operations per the ACME protocol.

Although examples herein are discussed with reference to the OAM 104 operating as the Token Authority, in some embodiments, a Token Authority may be implemented separate from the OAM 104. In such embodiments, a pre-established trust is to be provided between the OAM and a separately implemented Token Authority.

As noted above, system 100 of FIG. 1A assumes a trust relationship between the operator CA/RA 102 and the Token Authority (e.g., OAM 104), for example, that the operator CA/RA 102 is willing to accept the attestation of the Token Authority (e.g., OAM 104) for particular types of identifiers as sufficient proof to issue a credential.

Broadly, during operation of system 100, the mobile core NF 106 can make use of a token, also referred to herein as an authority token, in which the authority token contains a unique identifier/identity (ID) (referred to herein as an NF instance ID) that the mobile core NF 106 is assigned to represent itself within the mobile core network 110 in order to validate its authority to represent that unique ID. The unique ID (NF instance ID) can be assigned by the OAM 104, as generally shown at 132 of FIG. 1A. The term ‘NF instance ID’ is referred to herein in different formats, including ‘NfInstanceId’, ‘NFInstanceId’, ‘NFInstanceID’, and ‘nf-instance-id’; it is to be understood that any variations of the NF instance ID term are interchangeable for embodiments herein.

In at least one embodiment, the mobile core NF 106 can use the ACME protocol Authority Token Challenge type, “tkauth-01”, as specified in Internet Engineering Task Force (IETF) Request for Comments (RFC) 9447. In at least one embodiment, a new ACME Identifier Type can be defined that can be labeled herein as “nf-instance-id-list” (that can include a list of one NF instance ID value or multiple NF instance ID values) or, more simply, as can be labeled as a “nf-instance-id”.

The mobile core NF 106 can use its unique ID within the mobile core network 110 to construct its “nf-instance-id”. For a given mobile core NF, the “nf-instance-id” can typically contain a single value, the unique ID of the given mobile core NF. In at least one embodiment, a proxy for multiple NFs may, for example, can provide proxy signaling for multiple NF instances such that multiple nf-instance-ids can be supported by using multiple occurrences of corresponding nf-instance-ids. In at least one embodiment in accordance with techniques herein, a new authority token profile can be defined, referred to herein as an ‘NF Certificate Authority Token’ in which the NF Certificate Authority Token may be a profile instance of the ACME Authority Token, as defined in RFC 9447, including features as discussed for embodiments herein.

Broadly, operations discussed for embodiments herein may enable the mobile core NF 106 to use ACME, as defined at least per RFC 8555, to obtain one or more certificates from the operator CA/RA 102 through a certificate enrollment process (as generally shown at 134 of FIG. 1A) in which the certificate(s) enable the mobile core NF 106 to establish secure connections/communications with one or more other NFs (not shown) within the 5G SBA of mobile core network 110.

Certain operations of embodiments herein may be facilitated using the initial trust schema as defined in 3GPP Technical Specification (TS) 33.310. For example, during operation of system 100, as illustrated in FIG. 1A, an OAM 104 system can instantiate the mobile core NF 106 (as generally shown at 132), providing the mobile core NF 106 with the initial trust, via the NF instance ID value, that is to be utilized by the mobile core NF 106 for the certificate enrollment process (134) to be performed with the operator CA/RA 102. The NF instance ID, which uniquely identifies the mobile core NF 106 within the mobile core network 110, can be assigned to the mobile core NF 106 by the OAM 104 as part of or as a parameter of an NF profile provided for the mobile core NF 106 by the OAM 104, for example, as specified in Section 4.17 and Section 5.2.7.2.2 of 3GPP TS 23.502.

In various embodiments, the initial trust can be provided to the mobile core NF 106 via one of the following:
1. An OAM issued certificate;
2. An Initial Authentication Key (IAK); or
3. An OAM issued signature of certain NF profile parameters, at least including the NF instance ID.

When option (3) is used, the mobile core NF 106 can operate as the ACME client, the operator CA/RA 102 can operate as the ACME server, and the OAM 104 can operate as the Token Authority (or the OAM 104 can interface with a separately implemented Token Authority, assuming a pre-established trust between the OAM 104 and the separate Token Authority). The set of NF profile parameters in the payload signed by the OAM 104 (e.g., encrypted by the OAM using the private key of the OAM) and included in an authority token sent to the mobile core NF 106 includes the NF instance ID assigned to the mobile core NF 106 by the OAM 104. Including additional NF profile parameters in the authority token that the mobile core NF 106 is authorized to include in its certificate can simplify interaction between the OAM 104 and the operator CA/RA 102. Other entities, including the operator CA/RA 102 and NF can decrypt NF profile parameters signed by the OAM 104 using the public key of the OAM 104.

Per the ACME protocol, an ACME client can authenticate to an ACME server via an “account key pair.” The ACME client can use the private key of this key pair to sign all messages sent to the ACME server. The ACME server can use the public key to verify the authenticity and integrity of messages from the client. In at least one embodiment for system 100, the mobile core NF 106 can generate its own private/public key combination for use as an ACME client account key. Alternatively, the private/public key combination can be assigned by the OAM 104.

An ACME challenge-type that may be used may be the ACME Authority Token Challenge type, “tkauth-01”, as specified in RFC 9447. In addition to the tkauth-01 challenge-type, RFC 9447 describes an architecture for Authority Tokens, defines a JavaScript Object Notation (JSON) Web Token (JWT) (as prescribed by RFC 7519) Authority Token format along with a protocol for token acquisition, and provides for integrating these tokens into an ACME challenge. The architecture associated with this challenge-type assumes a trust relationship between a CA/RA (e.g., operator CA/RA 102) and a Token Authority (e.g., OAM 104), for example, that the CA/RA is willing to accept the attestation of a Token Authority for particular types of identifiers as sufficient proof for the CA/RA to issue a credential (e.g., a signed certificate, issued to an ACME client, such as mobile core NF 106).

As noted above, when using the ACME protocol in accordance with at least one embodiment, the OAM 104 can operate as the Token Authority that is trusted by the operator CA/RA 102. As such, the OAM 104 can, in at least one embodiment, be trusted to act as the authority for the NF Instance ID namespace within the mobile core network 110.

In accordance with embodiments herein, the new ACME Identifier Type, “nf-instance-id,” is defined such that a mobile core NF (e.g., mobile core NF 106) can use its (OAM 104 assigned) NF instance ID as the “nf-instance-id” ACME identifier. In at least one embodiment, the format of the entries in or the value of the “nf-instance-id” can be defined to match that of an NfInstanceId, as defined in 3GPP TS 29.571 to identify an NF instance, as follows:
. NfInstanceId: string: a string that uniquely identifying an NF instance. The format of the NF Instance ID can be a Universally Unique Identifier (UUID) version 4, as described in RFC 4122. The hexadecimal letters are to be formatted as lower-case characters by the sender and are to be handled as case-insensitive by the receiver.

For various example operations discussed herein, consider that mobile core NF 106 is assigned an NF instance ID of “82bf3ac2-3b11-5e00-2b4c-22ec61a3d51c” by the OAM 104 when the OAM 104 instantiates the mobile core NF 106 (e.g., as shown at 132). The NF instance ID can be identified in an authority token, referred to herein as an ‘NF Certificate Authority Token’, as discussed in further detail below, in which the NF Certificate Authority Token can be acquired by the mobile core NF 106 from the OAM 104 following instantiation of the NF by the OAM. It is to be understood that the NF instance ID of “82bf3ac2-3b11-5e00-2b4c-22ec61a3d51c” is an example NF instance ID that is provided for discussion purposes only and is not meant to limit the broad scope of embodiments herein. Any NF instance ID can be assigned to a mobile core NF in accordance with the ‘NfInstanceId’ definition provided above.

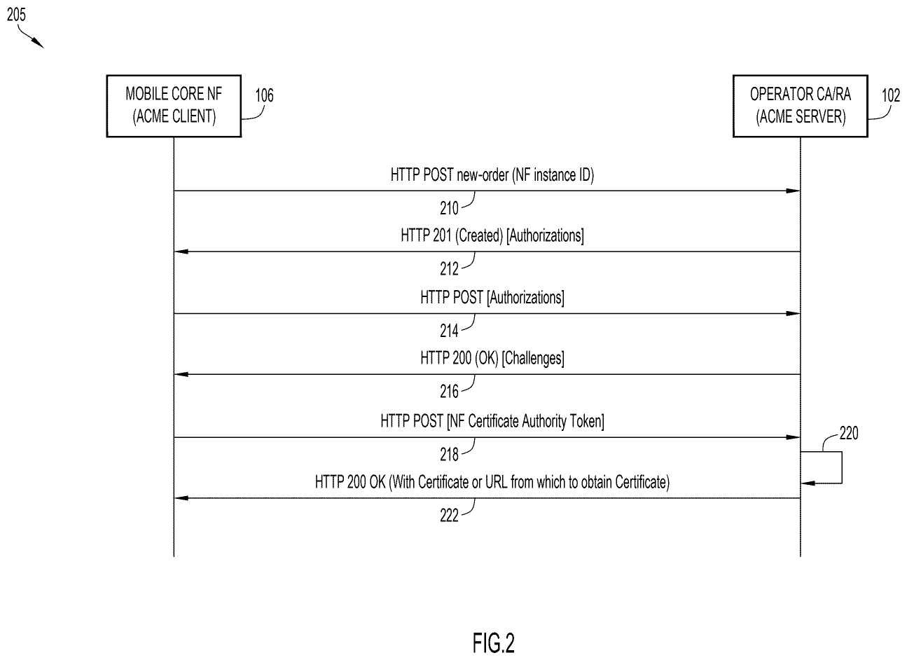

During operation of system 100, the mobile core NF 106 can provide its NF instance ID (e.g., “82bf3ac2-3b11-5e00-2b4c-22ec61a3d51c”) to the operator CA/RA 102 in a request for signed certificate for the certificate enrollment process 134 (discussed in more detail below with reference to FIG. 2). The request for a signed certificate is referred to as an ‘order’ per the ACME protocol. For example, as prescribed by RFC 8555, Clause 7.1.3, an ACME order object can represent an ACME client's request for a signed certificate and can be used to track the progress of the order (e.g., for the certificate enrollment process 134) to issuance of the certificate to the ACME client. An ACME order object can include several fields, including an “identifiers” field can include an array of identifier object(s) pertaining to the order.

An example of an ACME order object “identifiers” field containing a “nf-instance-id” as may be provided through embodiments herein may be defined as follows:
“identifiers”: [{“type”: “nf-instance-id”, “value”: “82bf3ac2-3b11-5e00-2b4c-22ec61a3d51c”}]

In at least one embodiment, the new “nf-instance-id” ACME Identifier Type can be provided or defined in a new registration in the ACME Validation Methods registry maintained by the Internet Assigned Numbers Authority (IANA), per RFC 9447, Clause 3.

In accordance with embodiments herein a new authority token profile is defined, referred to herein as an ‘NF Certificate Authority Token’ in which the NF Certificate Authority Token may be a profile instance of the ACME Authority Token as defined in RFC 9447. RFC 9447, Clause 3.2 defines that an Authority Token is used to answer a challenge from an ACME server (e.g., operator CA/RA 102) following a request (e.g., an order) for issuance of a certificate.

The NF Certificate Authority Token utilized for embodiments herein can include a protected header that complies with requirements for “Request Authentication,” as prescribed by Clause 6.2 of RFC 8555.

In various embodiments, the NF Certificate Authority Token payload can include the mandatory claims “exp” (expiration time), “jti” (JWT ID), and “atc” (authority token challenge) as follows:
An “exp” claim, as prescribed by RFC 7519, Section 4.1.4, is to be included and is to contain the Date Time value of the ending date and time that the NF Certificate Authority Token expires;
A “jti” claim, as prescribed by RFC 7519, Section 4.1.7, is to be included and is to contain a unique identifier for a given NF Certificate Authority Token transaction; and/or
An “atc” claim, as prescribed by RFC 9447, is to be included and is to contain a JSON object with the following elements:
   A “tktype” key with a string value equal to “NFInstanceId” to identify that the “tktype” is the NF instance ID claim;
   A “tkvalue” key with a string value equal to the value of the “nf-instance-id”; and
   A “fingerprint” key constructed as defined in RFC 8555, Clause 8.1, corresponding to the computation of the “Thumbprint” step using the ACME account key credentials.

Within the context of an authority token, a ‘claim’ can refer to any data/information that may be considered important to verify. In general, claims are used to exchange information between different entities in a secure and standardized manner such that the claims enable the transmission of authentication and authorization data, among other types of information. Additional “atc” claims for additional NF profile parameters can be included in accordance with embodiments herein but at least an “atc” claim for the NF Instance ID (“nf-instance-id”) is to be included in the NF Certificate Authority Token payload. For example, in various embodiment, other “atc” claims can include NF type, FQDN (Fully Qualified Domain Name, IPv4/IPv6 address, Public Land Mobile Network (PLMN) Identifier (ID), or the like, as defined at least in 3GPP TS 29.510.

In at least one instance, an NF Certificate Authority Token that can be provided (for mobile core NF 106, for example) can be formatted as follows:

```
{
  “protected”: base64url({
    “typ”:“JWT”,
    “alg”:“ES256”,
    “x5u”:“https://authority.example.org/cert”
  }),
  “payload”: base64url({
    “exp”:1640995200,
    “jti”:“id6098364921”,
    “atc”:{“tktype”:“NFInstanceId”,
      “tkvalue”:“82bf3ac2-3b11-5e00-2b4c-22ec61a3d51c”,
      “fingerprint”:“SHA256 56:3E:CF:AE:83:CA:4D:15:B0:29:FF:1B:71:
        D3:BA:B9:19:81:F8:50:9B:DF:4A:D4:39:72:E2:B1:F0:B9:38:E3”}
  }),
  “signature”: “9cbg5JO1Gf5YLjjz...SpkUfcdPai9uVYYQ”
}
```

Reference is now made to FIG. 1B, which is a sequence diagram 150 depicting various operations that can be performed between the OAM 104 and the mobile core NF 106 for provisioning the NF Certificate Authority Token for the mobile core NF 106 in accordance with embodiments herein.

As generally shown at 152, the OAM 104 instantiates the mobile core NF 106 by configuring the mobile core NF (e.g., configuring the mobile core NF per 3GPP standards, such as 3GPP TS 23.501 and 28.531) and assigns the NF instance ID (82bf3ac2-3b11-5e00-2b4c-22ec61a3d51c) to the mobile core NF 106.

Under the procedure as provided in RFC 9447, Clause 5, the NF Certificate Authority Token can be acquired by the mobile core NF 106 using a Representational State Transfer (RESTful) Hypertext Transfer Protocol (HTTP) POST transaction that can include the mobile core NF 106 sending a POST request to the OAM 104 as generally shown at 154 (in order to obtain the NF Certificate Authority Token from the OAM 104) that, in at least one embodiment, may be formatted as follows:
POST/at/account/: id/token HTTP/1.1
Host: authority.example.org
Content-Type: application/json

The POST request to obtain the NF Certificate Authority Token can pass an account identifier as a string in the request parameter “id”. This string can be managed as an identifier specific to the Token Authority's (e.g., the OAM's) relationship with the operator CA/RA. In at least one embodiment, the “account id” and corresponding credential could be provisioned by the OAM 104 in the mobile core NF 106 for the NF to use when requesting a token. Alternatively, in at least one embodiment, the OAM 104 may provision the mobile core NF 106 with the authority token upon instantiation, thus removing the need for the NF to explicitly request the authority token.

In at least one embodiment, a corresponding authentication procedure can be provided for system 100 that can be verified for the success of the transaction between the OAM and a given mobile core NF, for example, an HTTP authorization header containing valid authorization credentials, for example, as defined in RFC 9110, Section 11.6.2.

The body of the POST request can contain a JSON object with key value pairs corresponding to values that are requested as the content of the claims in an issued token. In at least one embodiment, the body can contain a JSON object including a “tktype” field set to “NFInstanceId” to indicate that the corresponding value contained in a “tkvalue” field of the JSON object is the NF instance ID (e.g., “82bf3ac2-3b11-5e00-2b4c-22ec61a3d51c” as assigned to the mobile core NF 106 by the OAM 104). In at least one embodiment, the body of the POST request including the JSON object can be formatted as follows:

```
{
  “tktype”:“NFInstanceId”,
  “tkvalue”:“82bf3ac2-3b11-5e00-2b4c-22ec61a3d51c”,
  “fingerprint”:“SHA256 56:3E:CF:AE:83:CA:4D:15:B0:29:FF:1B:71:D3
    :BA:B9:19:81:F8:50:9B:DF:4A:D4:39:72:E2:B1:F0:B9:38:E3”
}
```

The OAM 104 processes the request, as generally shown at 156, to create the NF Certificate Authority Token. When creating the NF Certificate Authority Token, the OAM 104 (e.g., operating as the Token Authority) can validate that the information contained in the NF Certificate Authority Token accurately represents the NF instance ID and additional NF profile parameters that the requesting party (e.g., mobile core NF 106) is authorized to represent based on their pre-established, verified, and secure relationship between the OAM 104 and the requesting party (e.g., mobile core NF 106). For example, given that the OAM 104 created/instantiated the mobile core NF 106 and knows the NF profile parameters that the NF should have, the OAM 104 can verify that the information in the token is accurate for the requesting mobile core NF 106. As noted above, the OAM 104 can include at least the NF instance ID of the mobile core NF 106 (and potentially other signed NF parameters) in the signed payload of the NF Certificate Authority Token. As such, the NF Certificate Authority Token can be referred to herein as a signed NF Certificate Authority Token that is signed by the OAM 104.

It is noted that the fingerprint in the token request sent by the mobile core NF 106 to the OAM 104 at 154 is not meant to be verified by the OAM 104 but rather is meant to be signed as part of the NF Certificate Authority Token so that the party that requests the token (e.g., mobile core NF 106) can, as part of a challenge response (discussed in more detail below, with reference to FIG. 2), allow the ACME server (operator CA/RA 102) to validate that the token requested and used came from the same party (e.g., the mobile core NF 106) that controls the ACME client (mobile core NF 106). Stated differently, the fingerprint enables to ACME server (operator CA/RA 102) to verify that the ACME client (mobile core NF 106) is using an NF Certificate Authority Token that was issued to the NF associated with the ACME client and not to some other NF.

If successful, the response by the OAM 104 to the POST request (received from the mobile core NF 106) can return an HTTP 200 (OK) response to the mobile core NF 106, as generally shown at 158, in which the HTTP response includes a JSON body that contains, at a minimum, the NF Certificate Authority Token as a JSON object with a key of “token” and a base64url-encoded string representing the “atc” token, or stated differently, the signed payload/all of the mandatory claims (i.e., “exp”, “jti”, and one or more “atc” claims) of the NF Certificate Authority Token, including the NF Instance ID. In at least one embodiment, a successful response may be formatted as follows:
HTTP/1.1 200 OK
Content-Type: application/json
{“token”: “DGyRejmCefe7v4N . . . vb29HhjjLPSggwiE”}

It is to be understood that the “token” field as identified in the example above may represent an encoded form of the example NF Certificate Authority Token (e.g., base64url encoding of the NF Certificate Authority Token), as discussed above, including NF parameters of the Token in which at least the NF instance ID parameter within the Token is signed by the OAM 104.

If the request is not successful, the response can indicate an error condition. Specifically, for the case that the authorization credentials are invalid or if the account identifier provided does not exist, the response code may be 403 (Forbidden). Other 4xx and 5xx responses can follow the standard HTTP error condition conventions, for example, as prescribed by RFC 9110.

As recommended in the Security Considerations section of RFC 9447, an Authority Token can either have a scope that attests all of the resources that a client is eligible to receive certificates for or potentially a more limited scope that is intended to capture only those resources for which a client will receive a certificate from a particular certification authority. Any certification authority that sees an Authority Token can learn information about the resources a client can claim. In cases where this may incur a privacy risk, the scope of the Authority Token can be limited to only the resources that will be attested by the requested ACME certificate.

Reference is now made to FIG. 2, which is a sequence diagram 205 depicting a certificate enrollment process, such as the certificate enrollment process 134 as generally illustrated in FIG. 1A, which can be performed between the mobile core NF 106 and the operator CA/RA 102 through which automated validation of a certificate signing request from the mobile core NF 106 can be provided in accordance with embodiments herein.

Broadly, the sequence diagram 205 illustrates example details through which certificate issuance can be facilitated for the mobile core NF using the ACME Authority Token challenge type through the certificate enrollment process (also referred to interchangeably as a certificate issuance process) as provided by embodiments herein.

As illustrated in FIG. 2 at 210, the mobile core NF 106 can initiate the certificate enrollment process by sending a POST request to a newOrder resource of the operator CA/RA 102. The body of the POST new-order request may be a JSON Web Signature (JWS) object whose JSON payload contains fields that describe the certificate to be issued to the mobile core NF 106, including the ACME identifiers. In at least one embodiment, the newOrder resource may be a URL that is configured for the mobile core NF 106 upon instantiation/configuration by the OAM 104.

NF certificates as discussed for embodiments herein may be inclusive of X.509 certificates, for example, as defined at least per 3GPP TS 33.310, Section 6.1.3c.3 (NF Certificate profile). In NF certificates, both client and server, the subjectAltName can contain a Uniform Resource Identifier ID (URI-ID) with the URI of the NfInstanceId as a Uniform Resource Name (URN) as described in 3GPP TS 29.571, Section 5.3.2. For mobile core NF 106, for example, “urn: uuid: 82bf3ac2-3b11-5e00-2b4c-22ec61a3d51c” can be the string representation of the NF Instance ID “82bf3ac2-3b11-5e00-2b4c-22ec61a3d51c” formatted as a URN.

In at least one embodiment, a full ACME new-order request that may be sent by the mobile core NF 106 at 210 can be formatted as follows:

```
POST /acme/new-order HTTP/1.1
Host: example.com
Content-Type: application/jose+json
{
  “protected”: base64url({
    “alg”: “ES256”,
    “kid”: “https://example.com/acme/acct/evOfKhNU60wg”,
    “nonce”: “5XJ1L3lEkMG7tR6pA00clA”,
    “url”: “https://example.com/acme/new-order”
  }),
  “payload”: base64url({
    “identifiers”: [{“type”:“nf-instance-id”,“value”:“82bf3ac2-
3b11-5e00-2b4c-22ec61a3d51c”}],
    “notBefore”: “2024-05-01T00:00:00Z”,
    “notAfter”: “2024-05-08T00:00:00Z”
  }),
  “signature”: “H6ZXtGjTZyUnPeKn...wEA4TklBdh3e454g”
}
```

On receiving a valid new-order request, the operator CA/RA 102 can create an authorization object (as prescribed by RFC 8555, Section 7.1.4), containing a challenge that the NF's ACME client is to satisfy to demonstrate authority for the identifiers specified by the new order (in this case, the “nf-instance-id”). The operator CA/RA 102 adds an authorization object Uniform Resource Locator (URL), or more generally, an authorization internet address (for example, “https://example.com/acme/authz/1234,” as shown below), to the “authorizations” field of the order object and returns the order object to the mobile core NF 106 in the body of a 201 (Created) response, as shown at 212.

In at least one embodiment, the 201 (Created) response may be formatted as follows:

```
HTTP/1.1 201 Created
Content-Type: application/json
Replay-Nonce: MYAuvOpaoIiywTezizk5vw
Location: https://example.com/acme/order/1234
{
  “status”: “pending”,
  “expires”: “2024-05-08T00:00:00Z”,
  “notBefore”: “2024-05-01T00:00:00Z”,
  “notAfter”: “2024-05-08T00:00:00Z”,
  “identifiers”: [{“type”:“nf-instance-id”,“value”:“82bf3ac2-
3b11-5e00-2b4c-22ec61a3d51c”}],
  “authorizations”: [
    “https://example.com/acme/authz/1234”
  ],
  “finalize”: “https://example.com/acme/order/1234/finalize”
}
```

On receiving the new-order response, the mobile core NF 106 can transmit a challenge query to the operator CA/RA 102 using the authorizations internet address to obtain challenges for the identifier (the “nf-instance-id” of the mobile core NF 106 in this example) contained in the new-order request that was sent at 210. For example, as shown at 214, the mobile core NF 106 can issue a POST request to query the referenced authorization object in order to obtain the challenges for the identifier (the “nf-instance-id” of the mobile core NF 106 in this example) contained in the new-order request.

As shown at 216, the operator CA/RA 102 can respond to the challenge query with a “challenges” response indicating an Authority Token challenge type and including a “challenges” URL (more generally, a challenge internet address)

When processing a certificate order containing an identifier of the type “nf-instance-id”, the operator CA/RA 102 is to use the Authority Token challenge type of “tkauth-01” with a “tkauth-type” of “atc”, as defined in RFC 9447, to verify that the requesting ACME client (e.g., mobile core NF 106) has authenticated and authorized control over the requested resources represented by the “nf-instance-id” value.

In at least one embodiment, an example POST request (as can be sent by the mobile core NF at 214) may be formatted as follows:

```
POST /acme/authz/1234 HTTP/1.1
  Host: example.com
  Content-Type: application/jose+json
  {
    “protected”: base64url({
      “alg”: “ES256”,
      “kid”: “https://example.com/acme/acct/evOfKhNU60wg”,
      “nonce”: “uQpSjlRb4vQVCjVYAyyUWg”,
      “url”: “https://example.com/acme/authz/1234”
    }),
    “payload”: “”,
    “signature”: “nuSDISbWG8mMgE7H...QyVUL68yzf3Zawps”
  }
```

In at least one embodiment, an example corresponding challenges response (as can be sent by the operator CA/RA 102 to the mobile core NF 106 at 216) to the POST request can be formatted as follows:

```
HTTP/1.1 200 OK
Content-Type: application/json
Link: <https://example.com/acme/some-directory>;rel=“index”
{
  “status”: “pending”,
  “expires”: “2024-05-08T00:00:00Z”,
  “identifier”: {
    “type”:“nf-instance-id”,
    “value”:“82bf3ac2-3b11-5e00-2b4c-22ec61a3d51c”
  },
  “challenges”: [
    {
      “type”: “tkauth-01”,
      “tkauth-type”: “atc”,
      “token-authority”: “https://authority.example.org”,
      “url”: “https://example.com/acme/chall/prV_B7yEyA4”,
      “token”: “IlirfxKKXAsHtmzK29Pj8A”
    }
  ]
}
```

As shown above, the challenges response includes the NF instance ID of the mobile core NF 106. In at least one instance, the challenges “token” as shown in the challenges response, above, can be a random value, as prescribed at least by RFC 8555, Clauses 8.3 and 8.4, that uniquely identifies the challenge.

The mobile core NF 106 can use its NF Certificate Authority Token to demonstrate control of its NF instance ID. For example, as shown at 218, the mobile core NF 106 can respond to the challenge by posting the NF Certificate Authority Token to the challenge URL identified in the ACME authorization object that was sent by the operator CA/RA 102, via a POST request (e.g., also referred to herein as an ACME challenge response).

In at least one embodiment, an example POST request including the NF Certificate Authority Token that may be provided by the mobile core NF 106 can be formatted as follows:

```
POST /acme/chall/prV_B7yEyA4 HTTP/1.1
Host: example.com
Content-Type: application/jose+json
{
  “protected”: base64url({
  “alg”: “ES256”,
  “kid”: “https://example.com/acme/acct/evOfKhNU60wg”,
  “nonce”: “Q_s3MWoqT05TrdkM2MTDcw”,
  “url”: “https://example.com/acme/authz/asdf/0”
  }),
  “payload”: base64url({
  “tkauth”: “DGyRejmCefe7v4N...vb29HhjjLPSggwiE”
  }),
  “signature”: “9cbg5JO1Gf5YLjjz...SpkUfcdPai9uVYYQ”
}
```

The “tkauth” field may be, as defined in RFC 9448, a field in the challenge object specific to the tkauth-01 challenge type that is to contain the NF Certificate Authority Token. Recall, at 158 discussed for FIG. 1B, above, the NF Certificate Authority Token sent to the mobile core NF 106 is identified as, “token”: “DGyRejmCefe7v4N . . . vb29HhjjLPSggwiE”. The “tkauth” field shown above for the challenges POST sent by the mobile core NF 106 to the operator CA/RA 102 at 218 indicates the same value for the NF Certificate Authority Token, “DGyRejmCefe7v4N . . . vb29HhjjLPSggwiE”.

As shown at 220, the operator CA/RA 102 performs validation of the NF Certificate Authority Token received from the mobile core NF 106.

Consider various operations that can be performed by the operator CA/RA 102 to facilitate validation of an NF Certificate Authority Token obtained from a mobile core NF through an enrollment process. In various embodiments, upon receiving a response to the challenge, the operator CA/RA 102 can perform the following steps to determine the validity of the response or, stated differently, to validate the NF Certificate Authority Token:
Verify that the value of the “atc” claim is a well-formed JSON object containing the mandatory key values;
If there is an “x5u” parameter, verify the “x5u” parameter is an HTTPS (secure HTTP) URL with a reference to a certificate representing the trusted issuer of Authority Tokens for the ecosystem;
If there is an “x5c” parameter, verify the certificate array contains a certificate representing the trusted issuer of Authority Tokens for the ecosystem;
Verify the NF Certificate Authority Token signature using the public key of the certificate referenced by the token's “x5u” or “x5c” parameter;
Verify that an “atc” claim contains a “tktype” identifier with the value/string set to “NFInstanceId”, a “tkvalue” identifier with an “nf-instance-id” value matching the NF instance identifier value specified in the original challenge (e.g., the value of the “nf-instance-id” included in the challenges response sent from the CA/RA 102 to the mobile core NF 106, as discussed above at 216), and a “fingerprint” that is valid and matches the account key of the client making the request; and
Verify that the remaining claims are valid (e.g., verify that token has not expired and any additional “atc” claims are valid).

Upon successfully verifying the NF Certificate Authority Token obtained from the mobile core NF 106, the operator CA/RA 102 can send an HTTP 200 (OK) response communication to the mobile core NF 106, as generally shown at 222, that either includes a valid signed certificate for the mobile core NF 106 or includes a URL (e.g., a certificate internet address) from which the mobile core NF 106 can obtain the signed certificate.

JSON Web Signature (JWS) objects can be used in various operations in accordance with various embodiments herein. As prescribed by RFC 7515, JWS objects can include an “x5u” header parameter to refer to a certificate that can be used to validate a JWS signature. The URLs used in “x5u” are expected to provide the (required) certificate in response to a GET request, not a POST-as-GET, as used for the “certificate” URL in the ACME order object. This generally involves the ACME client (e.g., mobile core NF 106) downloading the certificate and hosting it on a public URL to make it accessible to relying parties. RFC 9448, Section 7, defines an optional mechanism for the operator CA/RA to host the certificate directly and provide a URL that the ACME client owner can directly reference in the “x5u” of their signed nf-instance-id.

In at least one embodiment, use of the “x5u” in a response (e.g., at 222) when the certificate status is “valid” can be provided as follows:

```
HTTP/1.1 200 OK
Content-Type: application/json
Replay-Nonce: CGf81JWBsq8QyIgPCi9Q9X
Link: <https://example.com/acme/directory>;rel=“index”
Location: https://example.com/acme/order/TOlocE8rfgo
{
  “status”: “valid”,
  “expires”: “2024-05-20T14:09:07.99Z”,
  “notBefore”: “2024-05-01T00:00:00Z”,
  “notAfter”: “2024-05-08T00:00:00Z”,
  “identifiers”: [
    “type”:“nf-instance-id”,
    “value”:“82bf3ac2-3b11-5e00-2b4c-22ec61a3d51c”
  ],
  “authorizations”: [“https://sti-ca.com/acme/authz/1234”],
  “finalize”: “https://example.com/acme/order/TOlocE8rfgo/finalize”,
  “certificate”: “https://example.com/acme/cert/mAt3xBGaobw”,
  “x5u”: “https://example.com/cert-repo/giJI53km23.pem”
}
```

Accordingly, embodiments herein may facilitate automated validation of certificate signing requests for network functions. The techniques provided herein may use the existing initial trust schema, as defined in TS 33.310, and illustrate how the components of the initial trust schema map to the corresponding components of the ACME protocol. This minimizes the impact of adding support for the ACME protocol within a 3GPP mobile core network environment.

Further, the techniques herein advantageously use the definition and format of NfInstanceId, as defined in TS 29.571, and provide various operations through which the NfInstanceId (NF instance ID or ‘nf-instance-id’) can be used as an ACME identifier for ACME protocol operations discussed herein. The techniques also describe how the NF instance ID can be used with the existing Authority Token challenge type, as defined in RFC 9447, which may be useful to eliminate updates to IETF standards.

The techniques support the inclusion of all NF profile parameters in both the NF Certificate Authority Token and the OAM issued signature. This approach can simplify any interactions between the OAM 104 and the operator CA/RA 102.

Further, embodiments herein can be supported under both the ACME protocol and under 3GPP standards. For example, the registration of a new ACME identifier type, “nf-instance-id” can be provided directly with IANA. The definition of the NF Certificate Authority Token as a profile instance of the ACME Authority Token can be provided directly within a 3GPP technical specification, such as within a new version of 3GPP TS 33.310. The Authority Token challenge type, “tkauth-01”, is one of multiple validation methods used in the ACME protocol.

Embodiments herein may be useful for a 5G SBA that can be secured using certificates across the large number of SBA components and NFs. Virtualization and increased modularity of NFs has resulted in multi-vendor environments becoming more prevalent. It is now common for NFs to come from different vendors, for the cloud native environment in which they run to come from yet another vendor, and for all of these to be independent of the CA/RA that is authoritative for the certificates used to secure communications. In such deployments, it is impractical to validate certificates manually. Thus, in such deployments, automated validation of certificate signing requests may be particularly advantageous.

Accordingly, embodiments herein may enable automated techniques for a mobile core NF, such as a 5GC NF, a nG core NF, or the like, to create and/or otherwise obtain authorized certificates that it can use to establish secure connections within a 3GPP SBA mobile core network environment.

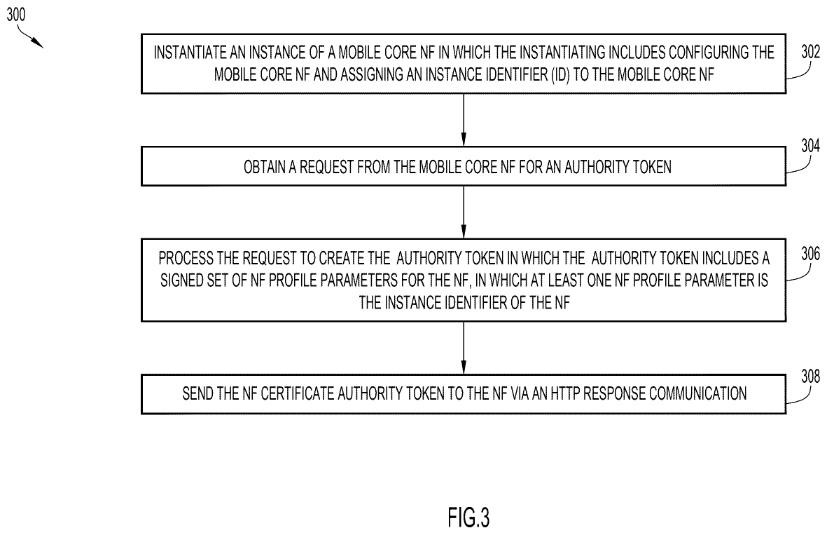

Referring to FIG. 3, FIG. 3 is a flow chart depicting a method 300 according to an example embodiment. In at least one embodiment, method 300 may be associated with operations that can be performed by a token authority service, such as OAM 104, in order to provision an NF Certificate Authority Token for a mobile core NF, such as mobile core NF 106.

As shown at 302, the method may include the OAM instantiating an instance of a mobile core NF in which the instantiating includes configuring the mobile core NF and assigning an instance identifier (ID) to the mobile core NF. The instance ID for the NF may be formatted as an NF instance ID as discussed for embodiments herein. For example, the instance ID for the NF may be formatted as a UUID version 4 identifier that uniquely identifies the NF within a mobile core network (e.g., mobile core network 110).

As shown at 304, the method may include obtaining, by the OAM (e.g., token authority service), a request from the mobile core NF for an authority token (e.g., NF Certificate Authority Token). The authority token (e.g., NF Certificate Authority Token) is to be used by the mobile core NF for a certificate enrollment process to be performed by the mobile core NF via an operator CA/RA, as discussed for embodiments herein. The request obtained by the OAM from the mobile core NF may be an HTTP POST request that include an account identifier associated with the mobile core NF and may include the instance ID of the NF as assigned to the NF by the OAM (e.g., at 302). The HTTP POST request can include a “tktype” field indicating the string “NFInstanceID” to indicate to the OAM that a value contained in a “tkvalue” field of the request is the instance ID of the NF (that the NF is claiming was provided to the NF by the OAM). The HTTP POST request can also include a “fingerprint” field.

As shown at 306, the method may include the OAM processing the request to create or generate the authority token (e.g., NF Certificate Authority Token) in which the authority token (e.g., NF Certificate Authority Token) includes a signed set NF profile parameters for the NF in which at least one NF profile parameter is the instance ID for the NF. Stated differently, the entire payload of the authority token is signed by the OAM. In at least one embodiment, processing the request can include the OAM validating that the information/parameters in the NF Certificate Authority Token accurately represents, at least in part, the instance ID of the NF (and potentially other parameters) that the NF is authorized to represent.

In at least one embodiment, the signed instance ID of the NF (e.g., signed “NFInstanceId”) is provided in an “atc” claim for the NF Certificate Authority Token.

As shown at 308, the method may include, upon creating the authority token (e.g., NF Certificate Authority Token), the OAM sending the authority token to the NF via an HTTP response communication (e.g., an HTTP 200 (OK) communication) that includes the authority token. The authority token can be included in a JSON object within a body of the HTTP response sent to the NF.

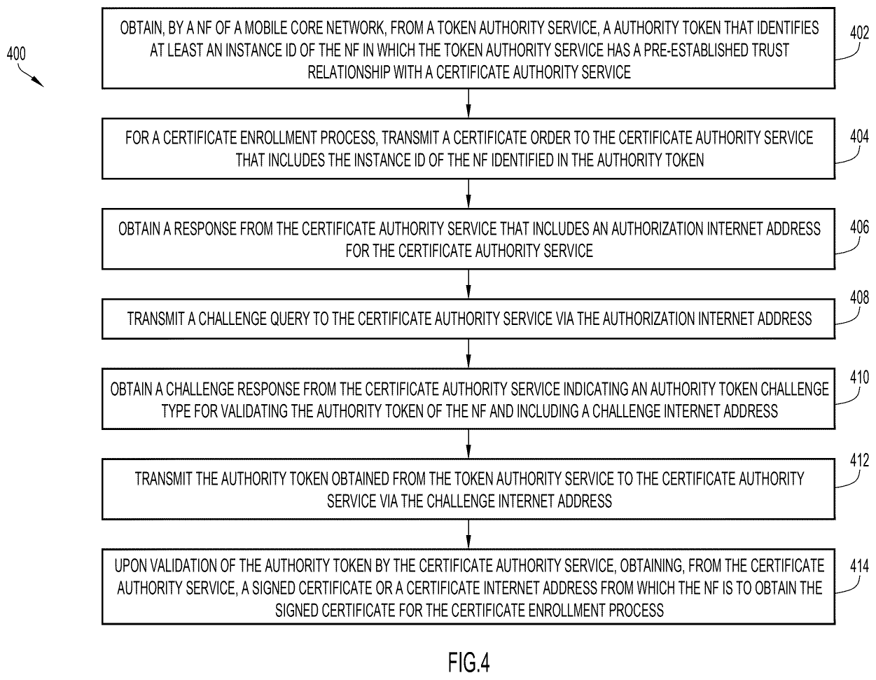

Referring to FIG. 4, FIG. 4 is a flow chart depicting a method 400 according to an example embodiment. In at least one embodiment, method 400 may be associated with operations that can be performed by a mobile core NF, such as mobile core NF 106, through which a certificate signing request sent by the mobile core NF can be automatically validated by a certificate authority service, such as operator CA/RA 102.

At 402, the method may include obtaining by a NF of a mobile core network, from a token authority service (e.g., OAM 104), an authority token (e.g., NF Certificate Authority Token) that identifies at least an instance identifier (ID) of the mobile core NF (e.g., “NFInstanceId”) in which the token authority service has a pre-established trust relationship with a certificate authority service.

At 404, for a certificate enrollment process, the method may include the NF of the mobile core network transmitting a certificate order to the certificate authority service that includes the instance ID of the NF identified in the authority token. In at least one embodiment, the certificate order may be an HTTP POST request communication sent by the NF to the certificate authority service that includes, at least in part, the instance ID of the NF, such as a value of an “nf-instance-id” included in the HTTP POST (e.g., “identifiers”: [{“type”: “nf-instance-id”, “value”: “82bf3ac2-3b11-5e00-2b4c-22ec61a3d51c”}]).

At 406, the method may include the NF of the mobile core network obtaining a response from the certificate authority service that includes an authorization internet address for the certificate authority service. In at least one embodiment, the response obtained from the certificate authority service may by an HTTP 201 response communication that includes the authorization internet address (e.g., via an “authorizations” field) within a body of the HTTP response. In at least one embodiment, the authorization internet address is a URL to which the NF is to transmit a challenge query.

At 408, the method may include the NF of the mobile core network transmitting a challenge query to the certificate authority service via the authorization internet address. In at least one embodiment, transmitting the challenge query may include transmitting an HTTP POST request by the NF to the certificate authority service using the authorization internet address in order to obtain challenges for the instance ID of the NF that was included in the certificate order sent by the NF to the certificate authority service.

At 410, the method may include the NF of the mobile core network obtaining a challenge response from the certificate authority service indicating an authority token challenge type for validating the authority token of the NF and including a challenge internet address.

In at least one embodiment, the challenge response may be an HTTP 200 (OK) response indicating an Authority Token challenge type of “tkauth-01” with a “tkauth-type” field indicating “atc”, which may indicate that the certificate authority service seeks to verify that the NF of the mobile core network has authenticated and authorized control over the instance ID of the NF. More specifically, the Authority Token challenge type of “tkauth-01” and the “tkauth-type” “atc” indication may indicate that the certificate authority service seeks to verify that the “nf-instance-id” value as identified in the certificate order obtained from the NF (e.g., at 404) is the same as/matches an “nf-instance-id” value contained in a NF Certificate Authority Token that the NF is to send to the certificate authority service. In at least on embodiment, the challenge internet address is a URL to which the NF is to transmit a challenge for the corresponding the challenge type, such as transmitting the NF Certificate Authority Token to the certificate authority service that is to be validated by the certificate authority service.

As shown at 412, the method may include the NF of the mobile core network transmitting the authority token obtained from the token authority service to the certificate authority service via the challenge internet address. In at least one embodiment, the transmitting may include transmitting an HTTP POST request to the certificate authority service that includes, as payload, a “tkauth” field in a challenge object that is specific to the “tkauth-01” challenge type and that includes the NF Certificate Authority Token itself.

As shown at 414, upon validation of the authority token by the certificate authority service, the method may include obtaining, from the certificate authority service, a signed certificate or a certificate internet address from which the NF is to obtain the signed certificate for the certificate enrollment process. In at least one embodiment, the signed certificate may be an X.509 certificate. In at least one embodiment, the obtaining may include obtaining an HTTP 200 (OK) response from the certificate authority service that includes the signed certificate or a certificate internet address from which the NF is to obtain the signed certificate.

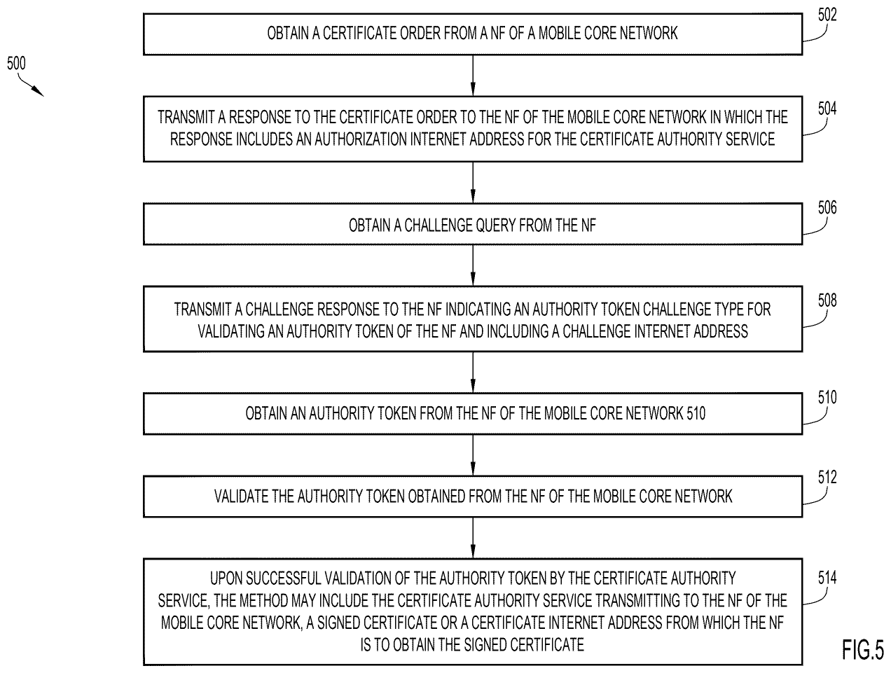

Referring to FIG. 5, FIG. 5 is a flow chart depicting a method 500 according to an example embodiment. In at least one embodiment, method 500 may be associated with operations that can be performed by a certificate authority service, such operator CA/RA 102, in order to facilitate automated validation of a certificate signing request obtained from a mobile core NF, such as mobile core NF 106 for a certificate enrollment process involving the mobile core NF.

At 502, the method may include the certificate authority service (e.g., operator CA/RA 102 obtaining a certificate order from a NF of a mobile core network (e.g., mobile core NF 106). In at least one embodiment, the certificate order may be an HTTP POST request communication obtained from NF by the certificate authority service that includes, at least in part, an instance ID of the NF, such as a value of an “nf-instance-id” included in the HTTP POST (e.g., “identifiers”: [{“type”: “nf-instance-id”, “value”: “82bf3ac2-3b11-5c00-2b4c-22ec61a3d51c”}]).

At 504, the method may include transmitting a response to the certificate order to the NF of the mobile core network in which the response includes an authorization internet address for the certificate authority service. In at least one embodiment, the response transmitted by certificate authority service may by an HTTP 201 response communication that includes the authorization internet address (e.g., via an “authorizations” field) within a body of the HTTP response. In at least one embodiment, the authorization internet address is a URL to which the NF is to transmit a challenge query.

At 506, the method may include obtaining, by the certificate authority service, a challenge query from the NF. In at least one embodiment, the challenge query may be an HTTP POST request sent by the NF to the certificate authority service using the authorization internet address indicating that the NF seeks to obtain challenges for the instance ID of the NF that was included in the certificate order sent by the NF to the certificate authority service.

At 508, the method may include the certificate authority service generating and transmitting a challenge response to the NF indicating an authority token challenge type for validating an authority token of the NF and including a challenge internet address.

In at least one embodiment, the challenge response may be an HTTP 200 (OK) response indicating an Authority Token challenge type of “tkauth-01” with a “tkauth-type” field indicating “atc”, which may indicate that the certificate authority service seeks to verify that the NF of the mobile core network has authenticated and authorized control over the instance ID of the NF. More specifically, the Authority Token challenge type of “tkauth-01” and the “tkauth-type” “atc” indication may indicate that the certificate authority service seeks to verify that the “nf-instance-id” value as identified in the certificate order obtained from the NF (e.g., at 502) is the same as/matches an “nf-instance-id” value contained in a NF Certificate Authority Token that the NF is to send to the certificate authority service. In at least on embodiment, the challenge internet address is a URL to which the NF is to transmit a challenge for the corresponding the challenge type.

As shown at 510, the method may include obtaining, by the certificate authority service, an authority token from the NF of the mobile core network. In at least one embodiment, the authority token can be obtained from the NF via an HTTP POST request sent by the NF to the certificate authority service that includes, as a payload, a “tkauth” field in a challenge object that is specific to the “tkauth-01” challenge type and that includes an NF Certificate Authority Token that the NF has obtained from a token authority service (e.g., OAM 104).

As shown at 512, the method may include the certificate authority service validating the authority token obtained from the NF of the mobile core network. In at least one embodiment, the authority token is an NF Certificate Authority Token that is an instance of an ACME Authority Token profile. In at least one embodiment, the validation of the authority token can be performed in accordance with validating claims of the token as prescribed at least by RFC 9448.

In at least one embodiment, validating the authority token by the certificate authority service may include the certificate authority service verifying that a value of an “atc” claim is a well-formed JSON object containing mandatory key values (e.g., the “tktype” key, “tkvalue” key, and “fingerprint” key being the mandatory keys of the “atc” claim, as prescribed by RFC 9448).

In at least one embodiment, validating the authority token by the certificate authority service may include the certificate authority service determining if there is an “x5u” parameter in the authority token. If there is an “x5u” parameter in the authority token, the validating may include the certificate authority service verifying that the “x5u” parameter is an HTTPS (secure HTTP) URL with a reference to a certificate representing the trusted issuer of Authority Tokens for a mobile core network in which the NF has been instantiated.

In at least one embodiment, validating the authority token by the certificate authority service may include the certificate authority service determining if there is an “x5c” parameter in the authority token. If there is an “x5c” parameter in the authority token, the validating may include the certificate authority service verifying the certificate array contains a certificate representing the trusted issuer of Authority Tokens for a mobile core network in which the NF has been instantiated.

In at least one embodiment, validating the authority token by the certificate authority service may include the certificate authority service verifying a signature of the authority token (e.g., NF Certificate Authority Token signature) using the public key of the certificate referenced by the token's “x5u” or “x5c” parameter.

In at least one embodiment, validating the authority token by the certificate authority service may include the certificate authority service verifying that an “atc” claim of the authority token contains a “tktype” identifier with the value or string corresponding to “NFInstanceId”, verifying that a “tkvalue” identifier with an “nf-instance-id” value of the authority token matches the instance identifier value specified in the original challenge (e.g., the challenge response sent to the NF), and verifying that a “fingerprint” included in the authority token is valid and matches an account key of the client making the request.

In at least one embodiment, validating the authority token by the certificate authority service may include the certificate authority service verifying that any remaining claims of the authority token are valid (e.g., verify that token has not expired and any additional “atc” claims are valid).

As shown at 514, upon successful validation of the authority token by the certificate authority service, the method may include the certificate authority service transmitting to the NF of the mobile core network, a signed certificate or a certificate internet address from which the NF is to obtain the signed certificate. In at least one embodiment, the signed certificate may be an X.509 certificate. In at least one embodiment, the transmitting may include transmitting an HTTP 200 (OK) response to the NF that includes the signed certificate or a certificate internet address from which the NF is to obtain the signed certificate.

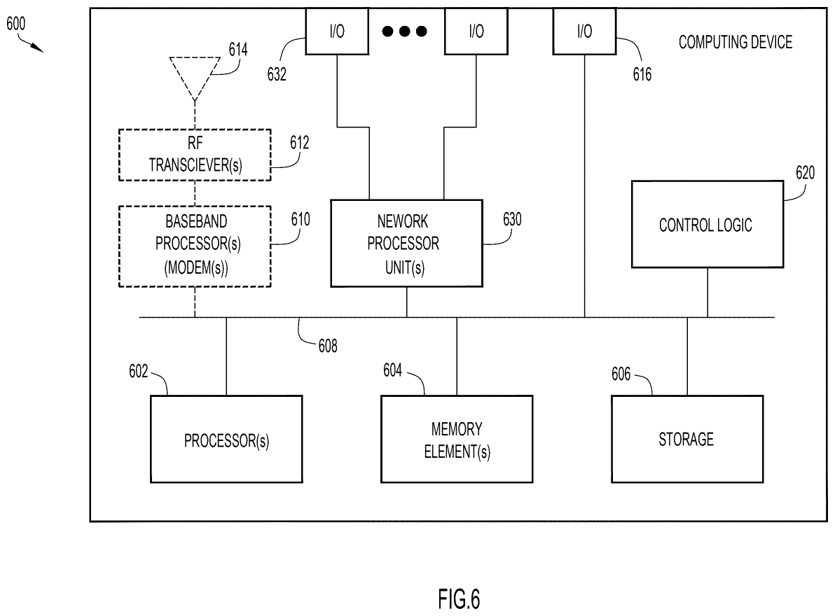

Referring to FIG. 6, FIG. 6 illustrates a hardware block diagram of a computing device 600 that may perform functions associated with operations discussed herein in connection with the techniques described for embodiments herein. In various embodiments, a computing device or apparatus, such as computing device 600 or any combination of computing devices 600, may be configured as any entity/entities in order to perform operations of the various techniques discussed for embodiments herein, such as any elements, functions, etc. discussed for embodiments herein.

In at least one embodiment, the computing device 600 may be any apparatus that may include one or more processor(s) 602, one or more memory element(s) 604, storage 606, a bus 608, one or more network processor unit(s) 630 interconnected with one or more network input/output (I/O) interface(s) 632, one or more I/O interface(s) 616, and control logic 620. In various embodiments, instructions associated with logic for computing device 600 can overlap in any manner and are not limited to the specific allocation of instructions and/or operations described herein.

For embodiments in which computing device 600 may be implemented as any device capable of wireless communications, computing device 600 may further include at least one baseband processor or modem 610, one or more radio RF transceiver(s) 612 (e.g., any combination of RF receiver(s) and RF transmitter(s)), one or more antenna(s) or antenna array(s) 614.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 630 may enable communication between computing device 600 and other systems, entities, etc., via network I/O interface(s) 632 (wired and/or wireless) to facilitate operations discussed for various embodiments described herein. In various embodiments, network processor unit(s) 630 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 632 can be configured as one or more Ethernet port(s), Fibre Channel ports, any other I/O port(s), and/or antenna(s)/antenna array(s) now known or hereafter developed. Thus, the network processor unit(s) 630 and/or network I/O interface(s) 632 may include suitable interfaces for receiving, transmitting, and/or otherwise communicating data and/or information (wired and/or wirelessly) in a network environment.

I/O interface(s) 616 allow for input and output of data and/or information with other entities that may be connected to computing device 600. For example, I/O interface(s) 616 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 600 is implemented as a wireless device or any apparatus capable of wireless communications, the RF transceiver(s) 612 may perform RF transmission and RF reception of wireless signals via antenna(s)/antenna array(s) 614, and the baseband processor or modem 610 performs baseband modulation and demodulation, etc. associated with such signals to enable wireless communications for computing device 600.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may facilitate automated validation of certificate signing requests for network functions. In one form, a computer-implemented method is provided that may include obtaining, by a mobile core NF from a token authority service, an authority token that identifies at least an instance identifier (ID) of the NF, wherein the token authority service has a pre-established trust relationship with a certificate authority service; for a certificate enrollment process, transmitting a certificate order to the certificate authority service that includes the instance ID of the NF identified in the authority token; obtaining a response from the certificate authority service that includes an authorization internet address for the certificate authority service; transmitting a challenge query to the certificate authority service via the authorization internet address; obtaining a challenge response from the certificate authority service indicating an authority token challenge type for validating the authority token of the NF and including a challenge internet address; transmitting the authority token obtained from the token authority service to the certificate authority service via the challenge internet address; and upon validation of the authority token by the certificate authority service, obtaining, from the certificate authority service, a signed certificate or a certificate internet address from which the NF is to obtain the signed certificate for the certificate enrollment process.

In at least one embodiment, the communications between the NF and the token authority service and between the NF and the certificate authority service include Automated Certificate Management Environment (ACME) protocol communications. The communications between the NF and the token authority service and between the NF and the certificate authority service are performed in accordance with RFC 9447, which is an extension of the ACME protocol.

In at least one embodiment, the instance ID of the NF is an ACME identifier type that is formatted as a Universally Unique Identifier (UUID) version 4 string and wherein the instance ID is assigned to the NF by the token authority service. In at least one embodiment, the instance ID of the NF is one of a plurality of NF profile parameters included in the authority token that are signed by the token authority service.

In at least one embodiment, obtaining the authority token from the token authority service includes transmitting a Hypertext Transfer Protocol (HTTP) POST request communication to the token authority service that includes an account identifier corresponding to an account established between the NF and the token authority service and includes the instance ID of the NF. In at least one embodiment, the token authority service is an Operations, Administration, and Maintenance (OAM) server. In at least one embodiment, the authority token is an NF Certificate Authority Token that is an instance of an ACME protocol Authority Token profile.

In at least one embodiment, the certificate order is included in a first Hypertext Transfer Protocol (HTTP) POST request communicated to the certificate authority service; the challenge query is included in a second HTTP POST request communicated to the certificate authority service; and the authority token is included in a third HTTP POST request communicated to the certificate authority service.

In at least one embodiment, the method may further include obtaining the signed certificate via the certificate internet address to enable the NF to securely communicate with one or more other network functions of the mobile core network.

In at least one embodiment, the mobile core network is a Third Generation Partnership Project (3GPP) Fifth Generation (5G) mobile core network or next Generation (nG) mobile core network.

In one form, a computer-implemented method is provided (e.g., as discussed above with reference at least to FIG. 3) that may include instantiating, by a network function management service, an instance of a mobile core NF in which the instantiating includes configuring the mobile core NF and assigning an instance identifier (ID) to the mobile core NF; obtaining, by the a network function management service, a request from the mobile core NF for a authority token (e.g., the NF Certificate Authority Token, as discussed for embodiments herein); creating, by the network function management service, the authority token in which the authority token includes one or more signed NF profile parameters in which at least one signed NF profile parameter is the instance ID of the mobile core NF; and upon creating the authority token, sending the authority token to the NF.

In at least embodiment, obtaining the request from the mobile core NF may include obtaining an HTTP POST request from the mobile core NF that includes an account identifier associated with the mobile core NF and that includes the instance ID of the NF as assigned to the NF network function management service. In at least one embodiment, the HTTP POST request includes a “tktype” field indicating the string “NFInstanceID” to indicate to the network function management service that a value contained in a “tkvalue” field of the request is the instance ID of the NF (that the NF is claiming was provided to the NF by the OAM). In at least one embodiment, the HTTP POST request can also include a “fingerprint” field.

In at least one embodiment, creating the authority token by the network function management service includes the network function management service validating or verifying the request obtained from the NF of the mobile core network.

In at least one embodiment, sending the authority token to the NF of the mobile core NF can include sending an HTTP response communication to the NF that includes the authority token. In at least one embodiment, the HTTP response communication is an HTTP 200 (OK) response communication that includes the authority token in which the authority token is an NF Certificate Authority Token that is an instance of an ACME protocol Authority Token profile.

In at least one embodiment, the signed instance ID of the NF is provided in an “atc” claim for the authority token. In at least one embodiment, the network function management service operates as OAM that includes an ACME protocol token authority service or that interfaces with an ACME protocol token authority service such that the network function management service operating at the OAM has a preestablished trust with the token authority service.

In one form, a computer-implemented method is provided (e.g., as discussed above with reference at least to FIG. 5) that may include obtaining, by a certificate authority service (e.g., operator CA/RA 102), a certificate order from a NF of a mobile core network; transmitting a response to the certificate order to the NF of the mobile core network in which the response includes an authorization internet address for the certificate authority service; obtaining a challenge query from the NF of the mobile core network; transmitting a challenge response to the NF indicating an authority token challenge type for validating an authority token of the NF and including a challenge internet address; obtaining an authority token from the NF of the mobile core network; validating the authority token obtained from the NF of the mobile core network; and upon successful validation of the authority token, transmitting to the NF of the mobile core network, a signed certificate or a certificate internet address from which the NF is to obtain the signed certificate.

In at least one embodiment, the certificate order may be an HTTP POST request communication obtained from NF by the certificate authority service that includes, at least in part, an instance ID of the NF, such as a value of an “nf-instance-id” included in the HTTP POST (e.g., “identifiers”: [{“type”: “nf-instance-id”, “value”: “82bf3ac2-3b11-5c00-2b4c-22ec61a3d51c”}]).

In at least one embodiment, transmitting the response to the certificate order may include transmitting an HTTP 201 response communication by the certificate authority service that includes the authorization internet address (e.g., via an “authorizations” field) within a body of the HTTP response. In at least one embodiment, the authorization internet address is a URL to which the NF of the mobile core network is to transmit a challenge query.

In at least one embodiment, obtaining the challenge query may include obtaining an HTTP POST request sent by the NF to the certificate authority service using the authorization internet address indicating that the NF seeks to obtain challenges for the instance ID of the NF that was included in the certificate order sent by the NF to the certificate authority service.

In at least one embodiment, the transmitting the challenge response to the NF of the mobile core network may include generating and transmitting the challenge response to the NF of the mobile core NF using an HTTP 200 (OK) response that indicates an Authority Token challenge type of “tkauth-01” with a “tkauth-type” field indicating “atc” to indicate that the certificate authority service seeks to verify that the NF of the mobile core network has authenticated and authorized control over the instance ID of the NF. More specifically, the Authority Token challenge type of “tkauth-01” and the “tkauth-type” “atc” indication may indicate that the certificate authority service seeks to verify that the “nf-instance-id” value as identified in the certificate order obtained from the NF is the same as/matches an “nf-instance-id” value contained in a NF Certificate Authority Token that the NF is to send to the certificate authority service. In at least on embodiment, the challenge internet address is a URL to which the NF is to transmit a challenge for the corresponding the challenge type.

In at least one embodiment, obtaining the authority token by the certificate authority service includes obtaining the authority token via an HTTP POST request sent by the NF to the certificate authority service that includes, as a payload, a “tkauth” field in a challenge object that is specific to the “tkauth-01” challenge type and that includes the authority token that the NF has obtained from a token authority service. In at least one embodiment, the authority token is an NF Certificate Authority Token that is an instance of an ACME Authority Token profile.

In at least one embodiment, the signed certificate may be an X.509 certificate. In at least one embodiment, the transmitting may include transmitting an HTTP 200 (OK) response to the NF that includes the signed certificate or a certificate internet address from which the NF is to obtain the signed certificate.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®/Wi-Fi7®/Wi-Fi8®/etc.), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and’ one or more of can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method performed via communications performed at least by a network function (NF) of a mobile core network, the method comprising:
obtaining, from a token authority service, an authority token that identifies at least an instance identifier (ID) of the NF, wherein the token authority service has a pre-established trust relationship with a certificate authority service;
for a certificate enrollment process, transmitting a certificate order to the certificate authority service that includes the instance ID of the NF identified in the authority token;
obtaining a response from the certificate authority service that includes an authorization internet address for the certificate authority service;
transmitting a challenge query to the certificate authority service via the authorization internet address;
obtaining a challenge response from the certificate authority service indicating an authority token challenge type for validating the authority token of the NF and including a challenge internet address;
transmitting the authority token obtained from the token authority service to the certificate authority service via the challenge internet address; and
upon validation of the authority token by the certificate authority service, obtaining, from the certificate authority service, a signed certificate or a certificate internet address from which the NF is to obtain the signed certificate for the certificate enrollment process.

2. The method of claim 1, wherein the communications between the NF and the token authority service and between the NF and the certificate authority service include Automated Certificate Management Environment (ACME) protocol communications.

3. The method of claim 2, wherein the instance ID of the NF is an ACME identifier type that is formatted as a Universally Unique Identifier (UUID) version 4 string and wherein the instance ID is assigned to the NF by the token authority service.

4. The method of claim 3, wherein the instance ID of the NF is one of a plurality of NF profile parameters included in the authority token that are signed by the token authority service.

5. The method of claim 1, wherein obtaining the authority token from the token authority service includes transmitting a Hypertext Transfer Protocol (HTTP) POST request communication to the token authority service that includes an account identifier corresponding to an account established between the NF and the token authority service and includes the instance ID of the NF.

6. The method of claim 1, wherein the token authority service is an Operations, Administration, and Maintenance (OAM) server.

7. The method of claim 1, wherein:
the certificate order is included in a first Hypertext Transfer Protocol (HTTP) POST request communicated to the certificate authority service;
the challenge query is included in a second HTTP POST request communicated to the certificate authority service; and
the authority token is included in a third HTTP POST request communicated to the certificate authority service.

8. The method of claim 1, further comprising:
obtaining the signed certificate via the certificate internet address to enable the NF to securely communicate with one or more other network functions of the mobile core network.

9. The method of claim 1, wherein the mobile core network is a Third Generation Partnership Project (3GPP) Fifth Generation (5G) mobile core network or next Generation (nG) mobile core network.

10. One or more non-transitory computer readable storage media encoded with instructions that, when executed by a processor, cause the processor to perform operations including communications, comprising:
obtaining, by a network function (NF) of a mobile core network from a token authority service, an authority token that identifies at least an instance identifier (ID) of the NF, wherein the token authority service has a pre-established trust relationship with a certificate authority service;
for a certificate enrollment process, transmitting a certificate order to the certificate authority service that includes the instance ID of the NF identified in the authority token;
obtaining a response from the certificate authority service that includes an authorization internet address for the certificate authority service;
transmitting a challenge query to the certificate authority service via the authorization internet address;
obtaining a challenge response from the certificate authority service indicating an authority token challenge type for validating the authority token of the NF and including a challenge internet address;
transmitting the authority token obtained from the token authority service to the certificate authority service via the challenge internet address; and
upon validation of the authority token by the certificate authority service, obtaining, from the certificate authority service, a signed certificate or a certificate internet address from which the NF is to obtain the signed certificate for the certificate enrollment process.

11. The media of claim 10, wherein communications between the NF and the token authority service and between the NF and the certificate authority service include Automated Certificate Management Environment (ACME) protocol communications.

12. The media of claim 11, wherein the instance ID of the NF is an ACME identifier type that is formatted as a Universally Unique Identifier (UUID) version 4 string and wherein the instance ID is assigned to the NF by the token authority service.

13. The media of claim 12, wherein the instance ID of the NF is one of a plurality of NF profile parameters included in the authority token that are signed by the token authority service.

14. The media of claim 10, wherein:
the certificate order is included in a first Hypertext Transfer Protocol (HTTP) POST request communicated to the certificate authority service;
the challenge query is included in a second HTTP POST request communicated to the certificate authority service; and
the authority token is included in a third HTTP POST request communicated to the certificate authority service.

15. An apparatus comprising:
at least one memory element for storing data; and
at least one processor for executing instructions associated with the data, wherein executing the instructions causes the apparatus to perform operations including communications, comprising:
obtaining, by a network function (NF) of a mobile core network from a token authority service, an authority token that identifies at least an instance identifier (ID) of the NF, wherein the token authority service has a pre-established trust relationship with a certificate authority service;
for a certificate enrollment process, transmitting a certificate order to the certificate authority service that includes the instance ID of the NF identified in the authority token;
obtaining a response from the certificate authority service that includes an authorization internet address for the certificate authority service;
transmitting a challenge query to the certificate authority service via the authorization internet address;
obtaining a challenge response from the certificate authority service indicating an authority token challenge type for validating the authority token of the NF and including a challenge internet address;
transmitting the authority token obtained from the token authority service to the certificate authority service via the challenge internet address; and
upon validation of the authority token by the certificate authority service, obtaining, from the certificate authority service, a signed certificate or a certificate internet address from which the NF is to obtain the signed certificate for the certificate enrollment process.

16. The apparatus of claim 15, wherein communications between the NF and the token authority service and between the NF and the certificate authority service include Automated Certificate Management Environment (ACME) protocol communications.

17. The apparatus of claim 16, wherein the instance ID of the NF is an ACME identifier type that is formatted as a Universally Unique Identifier (UUID) version 4 string and wherein the instance ID is assigned to the NF by the token authority service.

18. The apparatus of claim 17, wherein the instance ID of the NF is one of a plurality of NF profile parameters included in the authority token that are signed by the token authority service.

19. The apparatus of claim 15, wherein:
the certificate order is included in a first Hypertext Transfer Protocol (HTTP) POST request communicated to the certificate authority service;
the challenge query is included in a second HTTP POST request communicated to the certificate authority service; and
the authority token is included in a third HTTP POST request communicated to the certificate authority service.

20. The apparatus of claim 15, wherein the mobile core network is a Third Generation Partnership Project (3GPP) Fifth Generation (5G) mobile core network or next Generation (nG) mobile core network.
